(19) United States
(12) Patent Application Publication
(10) Pub. No.: US 2024/0387097 A1
(43) Pub. Date: Nov. 21, 2024

(54) WELDING TRANSFORMER

(71) Applicant: Panasonic Intellectual Property Management Co., Ltd., Osaka (JP)

(72) Inventors: Ryota CHINZAKA, Tokyo (JP); Kenta Tamagawa, Osaka (JP); Hidetoshi Oyama, Osaka (JP); Daiki Ito, Osaka (JP)

(21) Appl. No.: 18/789,062

(22) Filed: Jul. 30, 2024

Related U.S. Application Data
(63) Continuation of application No. PCT/JP2023/003370, filed on Feb. 2, 2023.

(30) Foreign Application Priority Data
Feb. 21, 2022 (JP) 2022-025033

(51) Int. Cl. H01F 27/29; H01F 27/32

(52) U.S. Cl. CPC H01F 27/29; H01F 27/32

(57) ABSTRACT

A primary-side coil includes a first unit circuit and a second unit circuit. The first unit circuit has a first external terminal that is a plate-like conductor. The second unit circuit has a second external terminal that is a plate-like conductor. An insulating spacer member is disposed between the first external terminal and the second external terminal.

### CROSS-REFERENCE TO RELATED APPLICATIONS

This is a continuation of International Application No. PCT/JP2023/003370 filed on Feb. 2, 2023, which claims priority to Japanese Patent Application No. 2022-025033 filed on Feb. 21, 2022. The entire disclosures of these applications are incorporated by reference herein.

### BACKGROUND

The present disclosure relates to welding transformers.

Japanese Unexamined Patent Application Publication No. 2000-223320 discloses a large current transformer that includes two split primary coils with a secondary coil interposed therebetween. Each primary coil is composed of a stuck of substantially U-shaped one-turn coils obtained by punching a copper plate.

### SUMMARY

In the invention of Japanese Unexamined Patent Application Publication No. 2000-223320, external terminals of the primary coils to which connection terminals of an external power supply are to be connected are in the form of a plate, and the rigidity of the external terminals is low. Therefore, if the connection terminals of the external power supply are fastened to the external terminals of the primary coils by bolts, the external terminals may be bent, and the external terminals of the two split primary coils may be short-circuited.

The present invention was made in view of the above circumstances, and an object of the present invention is to reduce short-circuiting between two external terminals due to bending of the external terminals.

According to a first aspect, a welding transformer includes a primary-side coil, the primary-side coil being a stack of a plurality of primary-side unit coils that is plate-like conductors. The primary-side coil includes a first unit circuit in which a predetermined number of the primary-side unit coils are connected in series, and a second unit circuit in which a predetermined number of the primary-side unit coils are connected in series. The primary-side unit coil includes a body portion extending in an annular shape and an external terminal extended from the body portion. The external terminal includes a first external terminal provided in the first unit circuit and a second external terminal provided in the second unit circuit. The welding transformer further includes an insulating spacer member disposed between the first external terminal and the second external terminal.

In the first aspect, the primary-side coil includes the first unit circuit and the second unit circuit. The first unit circuit includes the first external terminal that is a plate-like conductor. The second unit circuit includes the second external terminal that is a plate-like conductor. The insulating spacer member is disposed between the first external terminal and the second external terminal.

With this configuration, the spacer member can reduce bending of the first external terminal and the second external terminal toward each other. As a result, short-circuiting between the first external terminal and the second external terminal can be reduced.

According to a second aspect, the welding transformer of the first aspect further includes a reinforcing plate that extends along either or both of the first external terminal and the second external terminal.

In the second aspect, the reinforcing plate reinforces either or both of the first external terminal and the second external terminal against bending, so that their rigidity can be increased.

According to a third aspect, in the welding transformer of the second aspect, the reinforcing plate is disposed on opposing surfaces of the first external terminal and the second external terminal.

In the third aspect, since the reinforcing plate is disposed on the opposing surfaces of the first external terminal and the second external terminal, the rigidity of the first external terminal and the second external terminal is further increased, and workability is improved.

Specifically, when assembling the welding transformer, bolts are inserted from the outer surfaces of the external terminals to connect terminals of an external power supply and fasten the spacer member. At this time, the reinforcing plates placed on the inner surfaces of the external terminals are individually fastened or fastened together by the bolts. This improves workability.

According to a fourth aspect, the welding transformer of the third aspect further includes an insulating sheet that covers a surface of the primary-side unit coil, and part of the reinforcing plate is sandwiched between the primary-side unit coil and the insulating sheet.

In the fourth aspect, part of the reinforcing plate is sandwiched between the primary-side unit coil and the insulating sheet. This eliminates the need for a worker to hold the reinforcing plate so that it does not fall during the assembling work of the reinforcing plate, and thus improves workability.

According to a fifth aspect, in the welding transformer of the third or fourth aspect, each of the first external terminal and the second external terminal has a terminal hole through which a first bolt is inserted, and the reinforcing plate is provided with an internally threaded portion at a position corresponding to the terminal hole, the internally threaded portion being a portion through which the first bolt is tightened.

In the fifth aspect, the internally threaded portion is provided integrally with the reinforcing plate. This allows the first bolt for connecting the terminal to be tightened through the female threaded portion without using a nut besides the reinforcing plate, and thus improves workability.

According to a sixth aspect, in the welding transformer of the fifth aspect, the spacer member is fastened to the first external terminal and the second external terminal by a second bolt, and the reinforcing plate has a through hole through which the second bolt is inserted.

In the sixth aspect, the reinforcing plate can be fastened at two different positions by the first bolt and the second bolt. Therefore, rotation of the reinforcing plate about one bolt can be restricted by the other bolt. As a result, loosening of the bolts due to rotation of the reinforcing plate can also be reduced.

According to the aspects of the present disclosure, short-circuiting between the two external terminals due to bending of the external terminals can be reduced.

### BRIEF DESCRIPTION OF THE DRAWINGS

FIG. 1 is a perspective view of a welding transformer according to an embodiment as viewed from primary-side external terminals.

FIG. 2 is a perspective view of the welding transformer as viewed from secondary-side external terminals.

FIG. 3 is an exploded perspective view of a main part of the welding transformer.

FIG. 4 is an exploded perspective view of a magnetic core.

FIG. 5 is a plan view of a first unit coil.

FIG. 6 is a plan view of a second unit coil.

FIG. 7 is an exploded schematic view of an upper left portion surrounded by a dashed line in FIG. 3.

FIG. 8 is a plan view of a secondary-side unit coil.

FIG. 9 is an exploded schematic view of a lower right portion surrounded by a dashed line in FIG. 3.

FIG. 10 is a side view showing the configuration around external terminals of a primary-side coil.

FIG. 11 is a perspective view showing the configuration of a spacer member.

FIG. 12 is a perspective view showing the configuration of a reinforcing plate.

### DETAILED DESCRIPTION

Hereinafter, an embodiment of the present invention will be described with reference to the drawings. It should be noted that the following description of the preferred embodiment is merely illustrative in nature, and is not intended to limit the present invention, its applications, or its uses.

### Configuration of Welding Transformer

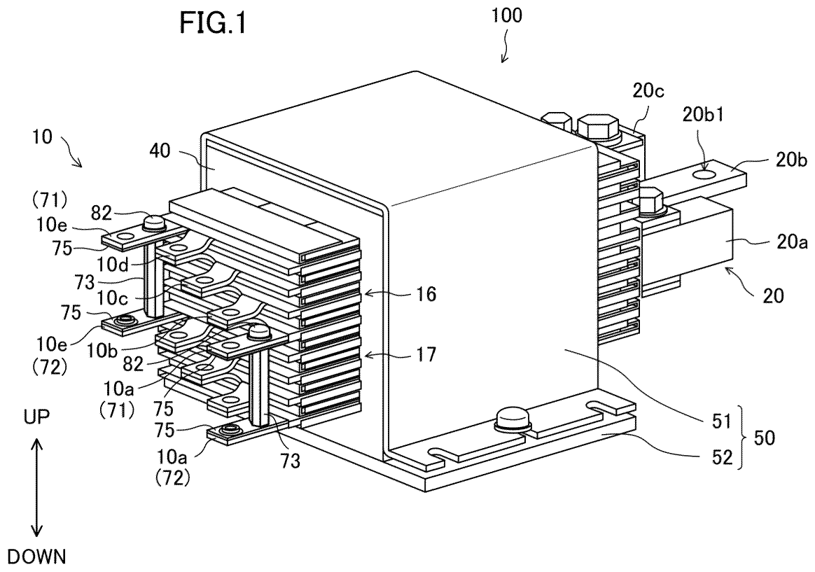

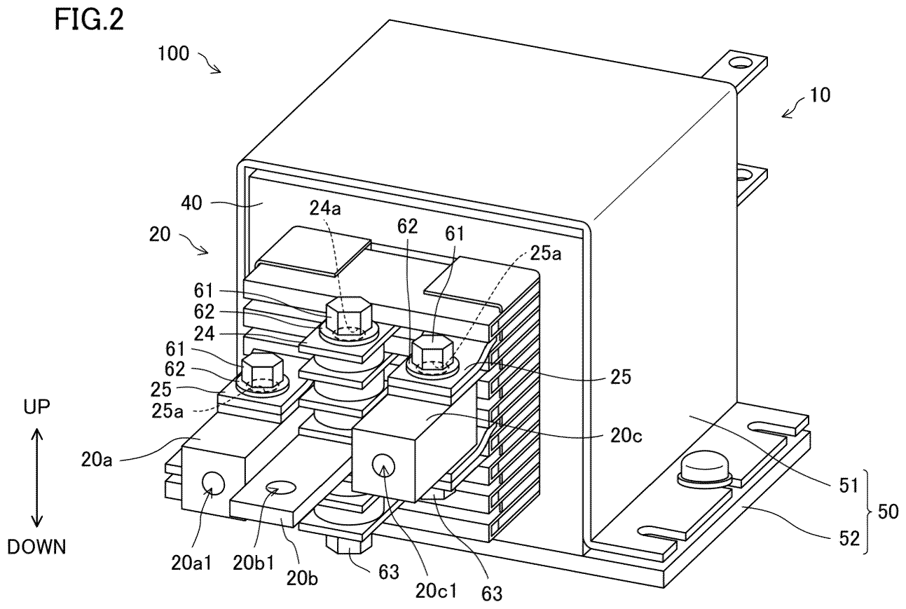

As shown in FIGS. 1 and 2, a welding transformer 100 includes a primary-side coil 10, a secondary-side coil 20, a magnetic core 40, and a fixture 50. For example, the welding transformer 100 is used as a voltage converter unit for a welding inverter power supply (not shown).

In the following description, the side on which a holding plate 51 of the fixture 50 shown in FIG. 1 is provided is sometimes referred to as upper or upper side. The opposite side, namely the side on which a support plate 52 is provided, is sometimes referred to as lower or lower side.

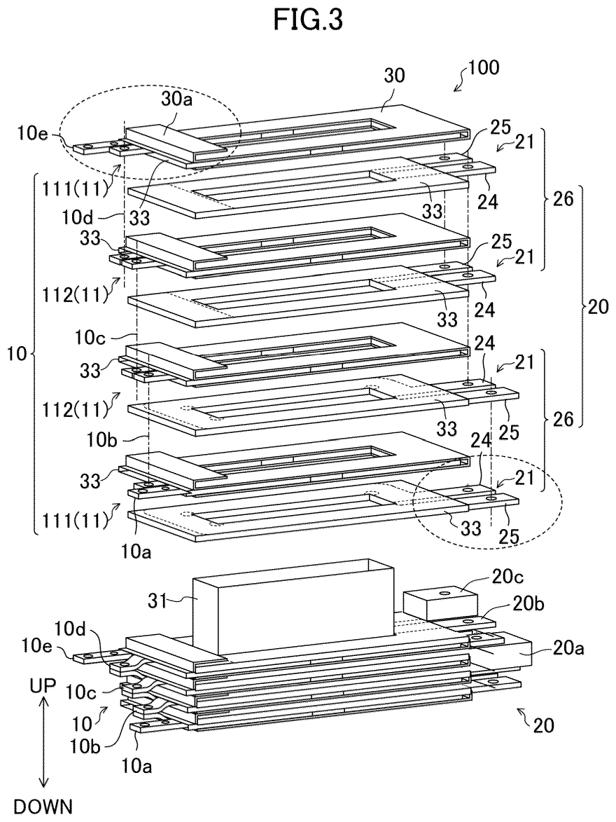

As shown in FIGS. 1 and 3, the primary-side coil 10 is configured as unit circuits each composed of four primary-side unit coils 11 connected in series with each other. The unit circuit has five external terminals. In the example shown in FIG. 1, the primary-side coil 10 includes two unit circuits. However, the number of unit circuits included in the primary-side coil 10 is not particularly limited to this. The number of unit circuits included in the primary-side coil 10 may be one, or may be three or more, and may be changed as appropriate according to the specifications required for the welding transformer 100. The primary-side unit coil 11 is a one-turn coil made of a copper plate. This will be described in detail later. The manner in which the four primary unit coils 11 are connected will also be described later.

The primary-side coil 10 is a so-called high voltage-side coil to be connected to an external power supply, for example, an external commercial power supply. The number of turns of the primary-side coil 10 in the unit circuit is changed by changing the combination of two terminals to be connected to the external power supply out of five primary-side external terminals 10a to 10e.

For example, when the primary-side external terminal 10a and the primary-side external terminal 10e are connected to the external power supply, the number of turns of the primary-side coil 10 in the unit circuit is four turns. On the other hand, when the primary-side external terminal 10a and the primary-side external terminal 10b are connected to the external power supply, the number of turns of the primary-side coil 10 in the unit circuit is one turn.

The combination of the two terminals to be connected to the external power supply and therefore the number of turns of the primary-side coil 10 in the unit circuit can be changed according to the specifications required for the welding transformer 100.

The secondary-side coil 20 is configured as unit circuits each composed of four secondary-side unit coils 21. The unit circuit has three secondary-side external terminals 20a to 20c. The secondary-side external terminals 20a to 20c have external connection holes 20a1 to 20c1, respectively, to which wires for connection with other circuits are to be connected.

The number of unit circuits included in the secondary-side coil 20 is basically the same as the number of unit circuits included in the primary-side coil 10. Like the primary-side unit coil 11, the secondary-side unit coil 21 is also a one-turn coil made of a copper plate. This will be described later. The manner in which the four secondary-side unit coils 21 are connected will also be described later.

The secondary-side coil 20 is a so-called low voltage-side coil to be connected to internal bus bar wires (not shown) or internal circuit (not shown) such as a semiconductor power converter of an inverter power supply.

The number of turns of the secondary-side coil 20 in the unit circuit is changed by changing the combination of two terminals to be connected to the output side, namely the internal bus bar wires or internal circuit of the inverter power supply, out of the secondary-side external terminals 20a to 20c.

For example, when the secondary-side external terminal 20a and the secondary-side external terminal 20c are connected to the output side, the number of turns of the secondary-side coil 20 in the unit circuit is four turns. On the other hand, when the secondary-side external terminal 20a and the secondary-side external terminal 20b are connected to the output side, the number of turns of the primary-side coil 10 in the unit circuit is two turns.

Similarly, when the secondary-side external terminal 20c and the secondary-side external terminal 20b are connected to the output side, the number of turns of the primary-side coil 10 in the unit circuit is two turns. That is, the secondary-side external terminal 20b is an intermediate tap terminal. The combination of the two terminals to be connected to the output side and therefore the number of turns of the secondary-side coil 20 in the unit circuit can be changed according to the specifications required for the welding transformer 100.

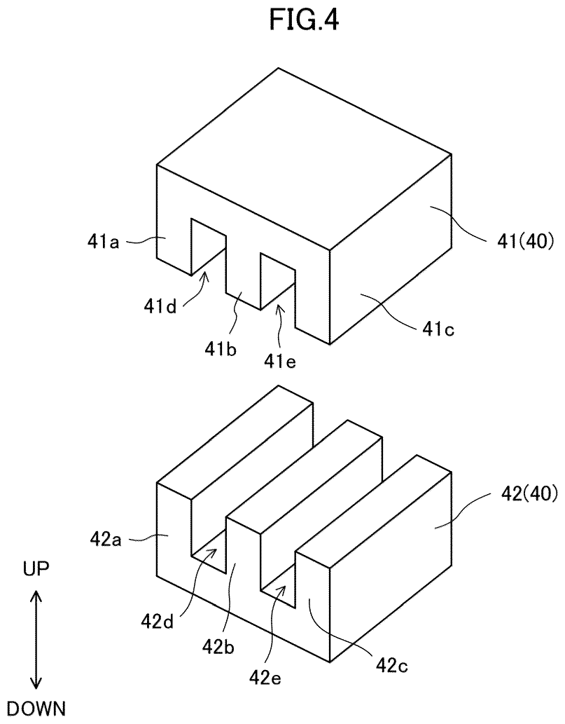

As shown in FIG. 4, the magnetic core 40 is a combination of two E-shaped cores 41, 42. In practical applications, four magnetic cores 40 are arranged side by side. However, the number of magnetic cores 40 to be used is not particularly limited to this, and may be changed as appropriate according to the size of the welding transformer 100, in particular, the sizes of the primary-side coil 10 and the secondary-side coil 20.

The E-shaped core 41 is made of a magnetic material such as ferrite and has three protrusions 41a to 41c and grooves 41d, 41e provided therebetween. The E-shaped core 42 is made of a magnetic material such as ferrite and has three protrusions 42a to 42c and grooves 42d, 42e provided therebetween. The protrusions 41b, 42b are disposed inside the primary-side coil 10 and the secondary-side coil 20. Two opposing sides of body portions 12, 22 (see FIGS. 3, 5, 6, and 8) of the primary-side coil 10 and the secondary-side coil 20 are accommodated in the grooves 41d, 42d and the grooves 41e, 42e.

Although the magnetic core 40 is not shown in FIG. 3, a tubular insulating sheet 31 is disposed inside the primary-side coil 10 and the secondary-side coil 20 so as to extend along the inner peripheral surfaces of the primary-side coil 10 and the secondary-side coil 20. This ensures insulation between the magnetic core 40 and the primary-side coil 10 and secondary-side coil 20.

As shown in FIGS. 1 and 2, the fixture 50 has the holding plate 51 and the support plate 52. The stack of the primary-side coil 10 and the secondary-side coil 20 with the magnetic core 40 mounted thereon is placed on the support plate 52, the stack is then held down from above by the holding plate 51, and the holding plate 51 is connected to the support plate 52 by a method such as screwing. The stack of the primary-side coil 10 and the secondary-side coil 20 with the magnetic core 40 mounted thereon is held and fixed in this manner.

### Configurations of Primary-Side and Secondary-Side Unit Coils

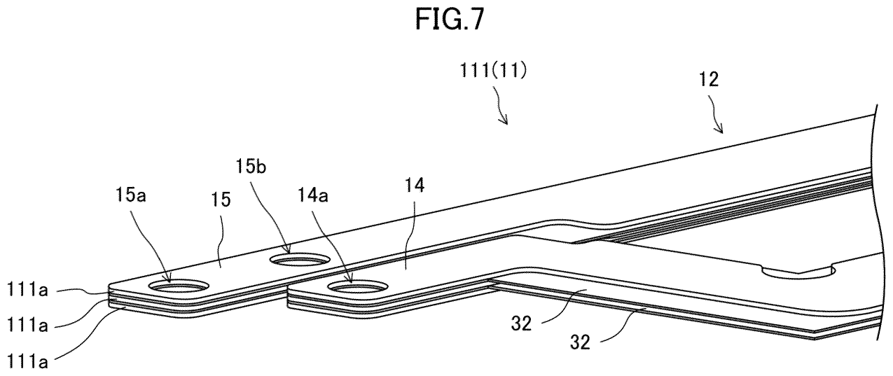

As shown in FIG. 3, the primary-side unit coils 11 include first unit coils 111 and second unit coils 112. As shown in FIG. 7, the first unit coil 111 is composed of a set of a plurality of (e.g., three) copper plates 111a having the same shape. Each of the copper plates 111a has a thickness of about 0.4 mm to 1.0 mm.

Insulating sheets 32 are sandwiched between the three stacked copper plates 111a. The stack of the three copper plates 111a and the two insulating sheets 32 shown in FIG. 7 is then wrapped in an insulating sheet 33 and is further wrapped in an insulating sheet 30. One first unit coil 111 shown in FIG. 3 is thus formed.

Although not shown in the figures, the second unit coil 112 is also composed of a set of a plurality of (e.g., three) copper plates having the same shape. Each of the copper plates has a thickness similar to that of the copper plates 111a.

Insulating sheets 32 are sandwiched between the three stacked copper plates, and the stack thus obtained is then wrapped in an insulating sheet 33 and is further wrapped in an insulating sheet 30. Each second unit coil 112 shown in FIG. 3 is thus formed.

The numbers of copper plates included in the first unit coil 111 and the second unit coil 112 are not particularly limited to the example shown in FIG. 7, and may be changed as appropriate according to the electrical resistance allowed for the primary-side coil 10, the number of turns of the primary-side coil 10, etc.

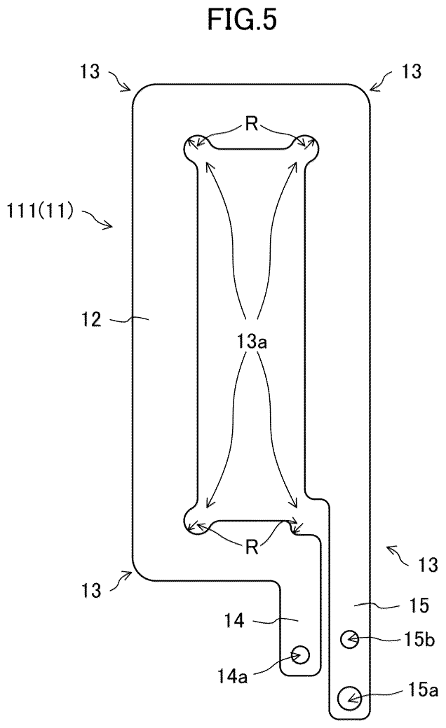

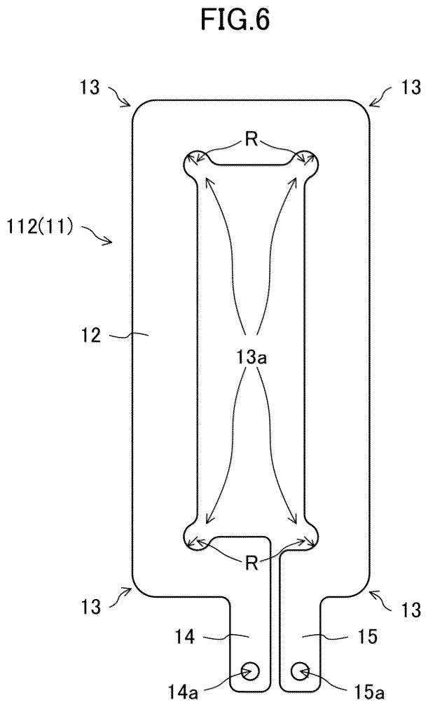

For example, the first unit coil 111 and the second unit coil 112 are obtained by punching a copper plate. The first unit coil 111 and the second unit coil 112 may alternatively be formed by bending a rectangular copper wire in the edge-wise direction (width direction). In this case, recesses 13a of corner portions 13, a terminal hole 14a of a first terminal portion 14, and a terminal hole 15a and insertion hole 15b of a second terminal portion 15, which will be described later, are formed by different processing (see FIGS. 5 and 6).

As shown in FIGS. 5 and 6, each of the first unit coil 111 and the second unit coil 112 has the body portion 12, the first terminal portion 14, and the second terminal portion 15.

The body portion 12 has a substantially quadrangular annular shape and has four corner portions 13. The recesses 13a that are recessed toward the outer periphery are formed in the inner peripheral surfaces of the four corner portions 13. The recesses 13a have a substantially circular outer shape as viewed in plan, and the recesses 13a are formed so that the recesses 13a in the four corner portions 13 have the same radius of curvature R. In other words, the recesses 13a are formed such that the body portion 12 is removed by the same distance R from the inner vertices that the corner portions 13 have when the recesses 13a are not formed.

The recesses 13a are formed so that their radius of curvature R is the same between the first unit coil 111 and the second unit coil 112. The outer shape and size of the body portion 12 are set to be the same between the first unit coil 111 and the second unit coil 112.

The first terminal portion 14 and the second terminal portion 15 are extended from both ends of the body portion 12, located side by side and spaced apart from each other, and extend in the same direction.

As shown in FIGS. 5 and 6, the positions of the first terminal portion 14 and the second terminal portion 15 are different between the first unit coil 111 and the second unit coil 112.

As shown in FIG. 5, the second terminal portion 15 of the first unit coil 111 is an extension from the end of one side of the body portion 12. The first terminal portion 14 is a portion extending from the end of another side of the body portion 12 that extends in a direction crossing the second terminal portion 15, and located next to and spaced apart from the second terminal portion 15.

As shown in FIG. 6, on the other hand, in the second unit coil 112, both ends of the body portion 12 are provided spaced apart from each other in one side of the body portion 12 that extends in a direction crossing the direction in which the first terminal portion 14 and the second terminal portion 15 extend. The first terminal portion 14 and the second terminal portion 15 extend side by side from one end and the other end of the body portion 12, respectively.

When the first unit coil 111 and the second unit coil 112 are stacked such that their body portions 12 are located exactly on top of each other, the first terminal portion 14 of the first unit coil 111 is positioned exactly on top of the second terminal portion 15 of the second unit coil 112 as viewed in plan. More specifically, the positions of the first terminal portion 14 (see FIG. 5) of the first unit coil 111 and the second terminal portion 15 (see FIG. 6) of the second unit coil 112 are set so that the terminal hole 14a (see FIG. 5) provided in the first terminal portion 14 of the first unit coil 111 is aligned with the terminal hole 15a (see FIG. 6) provided in the second terminal portion 15 of the second unit coil 112.

When two second unit coils 112 are stacked reversed with respect to each other (stacked front-to-front or back-to-back) such that their body portions 12 are located exactly on top of each other, the first terminal portion 14 of one second unit coil 112 is positioned exactly on top of the first terminal portion 14 of the other second unit coil 112 as viewed in plan. More specifically, the position of the first terminal portion 14 of the second unit coil 112 is set so that the terminal hole 14a provided in the first terminal portion 14 of one second unit coil 112 is aligned with the terminal hole 14a provided in the first terminal portion 14 of the other second unit coil 112.

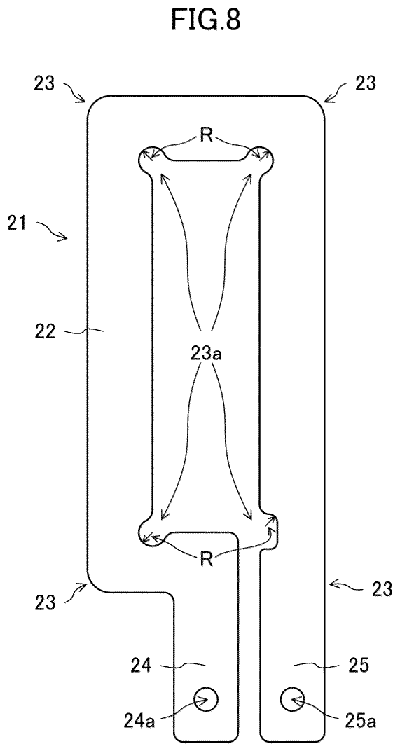

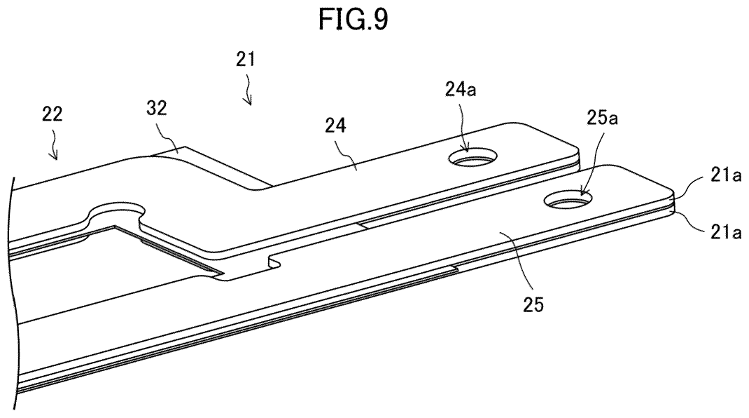

Like the first unit coil 111 (see FIG. 5) and the second unit coil 112 (see FIG. 6), the secondary-side unit coil 21 shown in FIGS. 8 and 9 is composed of a set of a plurality of (e.g., two) copper plates 21a having the same shape. Each of the copper plates 21a has a thickness of about 0.4 mm to 1.0 mm.

An insulating sheet 32 is sandwiched between the two stacked copper plates 21a. The stack of the two copper plates 21a and the one insulating sheet 32 shown in FIG. 9 is then wrapped in an insulating sheet 33. Each secondary-side unit coil 21 shown in FIG. 3 is thus formed.

The number of copper plates 21a included in the secondary-side unit coil 21 is not particularly limited to the example shown in FIG. 9, and may be changed as appropriate according to the electrical resistance allowed for the secondary-side coil 20, the number of turns of the secondary-side coil 20, etc. The secondary-side unit coil 21 is manufactured by a method similar to the method for the first unit coil 111 and the second unit coil 112 described above.

The secondary-side unit coil 21 shown in FIG. 3 is composed of a stack of two coils having the planar shape shown in FIG. 8. However, the secondary-side unit coil 21 is not particularly limited to this, and may be changed as appropriate according to the electrical resistance or current range allowed for the secondary-side coil 20. For example, the secondary-side unit coil 21 may be composed of only one coil having the planar shape shown in FIG. 8.

It should be understood that this also applies to the primary-side unit coil 11. For example, the first unit coil 111 may be composed of a stack of two coils having the planar shape shown in FIG. 5. The second unit coil 112 may be composed of a stack of two coils having the planar shape shown in FIG. 6.

As shown in FIG. 8, like the first unit coil 111 (see FIG. 5) and the second unit coil 112 (see FIG. 6), the secondary-side unit coil 21 has a body portion 22, a first terminal portion 24, and a second terminal portion 25.

The secondary-side unit coil 21 is also the same as the first unit coil 111 and the second unit coil 112 in the shape of the body portion 22 and in that recesses 23a are provided in the inner peripheral surfaces of four corners 23. The secondary-side unit coil 21 is also the same as the first unit coil 111 and the second unit coil 112 in that the recesses 23a are formed so that the recesses 23a in the four corner portions 23 have the same radius of curvature R, namely such that the body portion 22 is removed by the same distance R from the inner vertices that the corner portions 23 have when the recesses 23a are not formed.

The recesses 23a of the secondary-side unit coil 21 are formed so as to have the same radius of curvature R as the radius of curvature R of the recesses 13a of the first unit coil 111 and the second unit coil 112. In the secondary-side unit coil 21, the outer shape and size of the body portion 22 are set to be substantially the same as those of the first unit coil 111 and the second unit coil 112.

The first terminal portion 24 and the second terminal portion 25 are extended from both ends of the body portion 22 and extend side by side in the same direction.

As shown in FIG. 8, the second terminal portion 25 of the secondary-side unit coil 21 is an extension from the end of one side of the body portion 22. The first terminal portion 24 extends from the end of another side of the body portion 22 that extends in a direction crossing the second terminal portion 25, and is located next to and spaced apart from the second terminal portion 25.

When two secondary-side unit coils 21 are stacked reversed with respect to each other (stacked front-to-front or back-to-back) such that their body portions 22 are located exactly on top of each other, the first terminal portion 24 of one secondary-side unit coil 21 is positioned exactly on top of the first terminal portion 24 of the other secondary-side unit coil 21 as viewed in plan. More specifically, the position of the first terminal portion 24 of the secondary-side unit coil 21 is set so that a terminal hole 24a provided in the first terminal portion 24 of one secondary-side unit coil 21 is aligned with a terminal hole 24a provided in the first terminal portion 24 of the other secondary-side unit coil 21.

### Configurations of Primary-Side and Secondary-Side Coils

As shown in FIG. 3, the primary-side unit coil 11 is covered by the insulating sheet 30. The insulating sheet 32 is sandwiched between the plurality of copper plates of each of the primary-side unit coil 11 and the secondary-side unit coil 21 described above (see FIGS. 7 and 9). The stack of the one or more insulating sheets 32 and the plurality of copper plates is covered by the insulating sheet 33.

In this case, although not shown in the figures, each insulating sheet 33 is formed by making a plurality of cuts in a sheet of insulating paper. The number of cuts and their positions and lengths are according to the shapes of the primary-side unit coil 11 and the secondary-side unit coil 12, and each insulating sheet 33 is folded at the cuts to wrap the primary-side unit coil 11 and the secondary-side unit coil 21. Each surface of the primary-side unit coil can thus be completely covered by the insulating sheet 33 and the insulating sheet 30 except the first terminal portion 14 and the second terminal portion 15. Each surface of the secondary-side unit coil 21 can also be completely covered by the insulating sheet 33 except the first terminal portion 24 and the second terminal portion 25.

The insulating sheet 30 that covers the primary-side unit coil 11 has a folded-back portion 30a (see FIG. 3), and part of the secondary-side unit coil 21 covered by the insulating sheet 33 is wrapped in the folded-back portion 30a. However, the folded-back portion 30a need not necessarily be provided, and may be omitted.

The primary-side coil 10 and the secondary-side coil 20 are alternately arranged in order of the primary-side coil 10 and the secondary-side coil 20 from top to bottom.

As can be seen from FIG. 3, the primary-side unit coils 11 and the secondary-side unit coils 21 are alternately stacked such that the primary-side unit coils 11 and the secondary-side unit coils 21 are insulated from each other by the insulating sheets 30.

The first unit coils 111 and the second unit coils 112 that constitute the primary-side coil 10 are arranged as follows.

As the primary-side coil 10, the first unit coils 111 are placed at the first and fourth positions from the top, and the second unit coils 112 are placed at the second and third positions from the top. The first unit coil 111 placed at the fourth position is reversed with respect to the first unit coil 111 placed at the first position such that the positions of their terminal portions become symmetrical in their lateral direction. The second unit coil 112 placed at the third position is reversed with respect to the second unit coil 112 placed at the second position such that the positions of their terminal portions become symmetrical in their lateral direction.

Since the first unit coils 111 and the second unit coils 112 are arranged in this manner, the first terminal portion 14 of the first unit coil 111 placed at the fourth position and the second terminal portion 15 of the second unit coil 112 placed at the third position can be positioned exactly on top of each other as viewed from above, and the terminal holes 14a, 15a provided in the first and second terminal portions 14, 15, respectively, can be aligned with each other. The primary-side external terminal 10b (see FIGS. 1, 3) can be formed by passing a screw etc., not shown, through the two terminal holes 14a, 15a and tightening it.

Similarly, the first terminal portion 14 of the second unit coil 112 placed at the third position and the first terminal portion 14 of the second unit coil 112 placed at the second position can be positioned exactly on top of each other as viewed from above, so that the primary-side external terminal 10c (see FIGS. 1, 3) can be formed. The second terminal portion 15 of the second unit coil 112 placed at the second position and the first terminal portion 14 of the first unit coil 111 placed at the first position can be positioned exactly on top of each other as viewed from above, so that the primary-side external terminal 10d (see FIGS. 1, 3) can be formed. The second terminal portion 15 of the first unit coil 111 placed at the fourth position is the primary-side external terminal 10a (first external terminal 71, second external terminal 72), and the second terminal portion 15 of the first unit coil 111 placed at the first position is the primary-side external terminal 10e (first external terminal 71, second external terminal 72).

In this manner, the structure in which the four primary-side unit coils 11 are connected in series can be easily formed using only two types of unit coils, the first unit coils 111 and the second unit coils 112.

The secondary-side unit coils 21 (see FIGS. 3, 8, and 9) that constitute the secondary-side coil 20 (see FIGS. 1, 2, and 3) are arranged as follows.

As the secondary-side coil 20, the secondary-side unit coils 21 placed at the first and second positions from the top are arranged such that both of them face the same direction. The secondary-side unit coils 21 placed at the third and fourth positions from the top are arranged such that both of them face the same direction. On the other hand, the second-side unit coils 21 placed at the second and third positions are reversed with respect to each other. In other words, the secondary-side unit coils 21 placed at the third and fourth positions are reversed with respect to the secondary-side unit coils 21 placed at the first and second positions.

Since the four secondary-side unit coils 21 are arranged in this manner, the second terminal portion 25 of the secondary-side unit coil 21 placed at the fourth position and the second terminal portion 25 of the secondary-side unit coil 21 placed at the third position can be positioned exactly on top of each other as viewed from above, and terminal holes 25a provided in these second terminal portions 25 can be aligned with each other. As shown in FIG. 2, the second terminal portions 25 of the secondary-side unit coils 21 placed at the third and fourth positions and the secondary-side external terminal 20a can be connected by passing a bolt 61 through the two terminal holes 25a and a through hole (not shown) provided in the secondary-side external terminal 20a and tightening it.

Similarly, the first terminal portion 24 of the secondary-side unit coil 21 placed at the fourth position and the first terminal portion 24 of the secondary-side unit coil 21 placed at the third position can be positioned exactly on top of each other as viewed from above, and the first terminal portions 24 of the secondary-side unit coils 21 placed at the third and fourth positions and the secondary-side external terminal 20b can be connected using a bolt 61, a washer 62, and a nut 63. A parallel connection structure 26 (see FIG. 3) in which the secondary-side unit coil 21 placed at the third position and the secondary-side unit coil 21 placed at the fourth position are connected in parallel is configured in this manner.

The first terminal portions 24 of the secondary-side unit coils 21 placed at the second and first positions can be positioned exactly on top of the first terminal portions 24 of the secondary-side unit coils 21 placed at the third and fourth positions as viewed from above, and the terminal holes 24a provided in these first terminal portions 24 can be aligned with each other. Therefore, as shown in FIG. 2, the first terminal portions 24 of the secondary-side unit coils 21 placed at the first to fourth positions and the secondary-side external terminal 20b can be connected using the bolt 61, the washer 62, and the nut 63.

The second terminal portion 25 of the secondary-side unit coil 21 placed at the second position and the second terminal portion 25 of the secondary-side unit coil 21 placed at the first position can be positioned exactly on top of each other as viewed from above, and terminal holes 25a provided in these second terminal portions 25 can be aligned with each other. As shown in FIG. 2, the terminal holes 25a of the second terminal portions 25 of the secondary-side unit coils 21 placed at the first and second positions and the secondary-side external terminal 20c can be connected by passing a bolt 61 through the two terminal holes 25a and a through hole (not shown) provided in the secondary-side external terminal 20c and tightening it.

A parallel connection structure 26 (see FIG. 3) in which the secondary-side unit coil 21 placed at the first position and the secondary-side unit coil 21 placed at the second position are connected in parallel is configured in this manner. The two parallel connection structures 26 are connected in series.

### About Spacer Members and Reinforcing Plates

As shown in FIG. 1, the primary-side coil 10 has the five primary-side external terminals 10a to 10e. The primary-side external terminals 10b to 10d are each formed by placing the first terminal portion 14 (see FIG. 5) of the first unit coil 111 and the second terminal portion 15 (see FIG. 6) of the second unit coil 112 on top of each other. Therefore, the individual thicknesses of the primary external terminals 10b to 10d are the total thickness of two unit coils, and the rigidity of the primary external terminals 10b to 10d is high.

On the other hand, the primary-side external terminals 10a, 10e are each formed by the second terminal portion 15 (see FIG. 5) of the first unit coil 111. Therefore, the individual thicknesses of the primary-side external terminals 10a, 10e are as small as the thickness of one unit coil. When connection terminals of an external power supply, not shown, are fastened to the primary-side external terminals 10a, 10e of the primary-side coil 10 by bolts, the primary-side external terminals 10a, 10e may be bent, and the external terminals of the two unit circuits may be short-circuited.

Accordingly, the present embodiment reduces short-circuiting of the two external terminals due to bending of the external terminals.

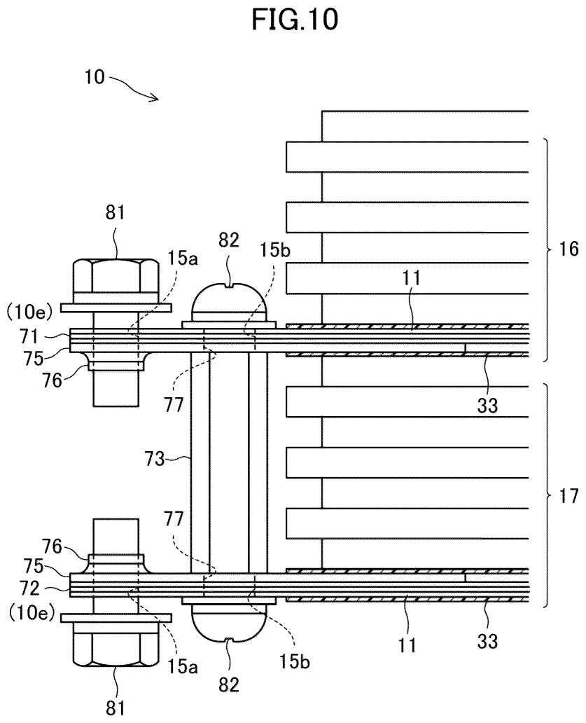

Specifically, as shown in FIGS. 1 and 10, the primary-side coil 10 includes a first unit circuit 16 in which a predetermined number of primary-side unit coils 11 are connected in series, and a second unit circuit 17 in which a predetermined number of primary-side unit coils 11 are connected in series.

The first unit circuit 16 is provided with the primary-side external terminals 10a to 10e. In the following description, of the primary-side external terminals 10a to 10e of the first unit circuit 16, the primary-side external terminals 10a, 10e will be referred to as first external terminals 71.

The second unit circuit 17 is provided with the primary-side external terminals 10a to 10e. In the following description, of the primary-side external terminals 10a to 10e of the second unit circuit 17, the primary-side external terminals 10a, 10e will be referred to as second external terminals 72.

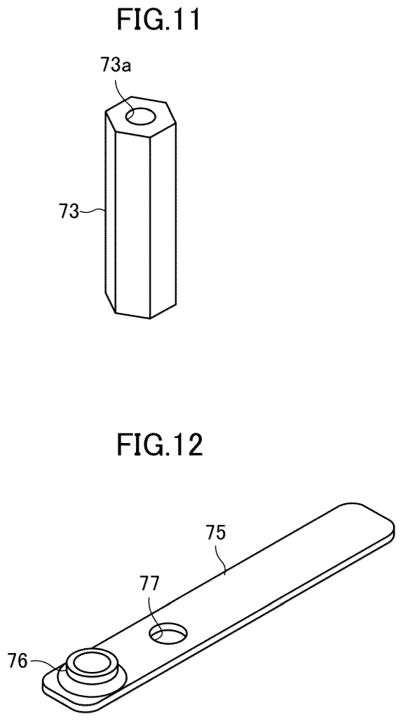

The first external terminal 71 and the second external terminal 72 are disposed spaced apart from each other in the vertical direction. A spacer member 73 is disposed between the first external terminal 71 and the second external terminal 72. As is also shown in FIG. 11, the spacer member 73 is formed in the shape of a hexagonal prism. The shape of the spacer member 73 is not limited to this.

The spacer member 73 has insulating properties. The spacer member 73 is made of, for example, a resin having a heat-resistant temperature of 155° or more. This ensures that the insulation class (F) of the welding transformer 100 will not be degraded. Screw holes 73a are formed in both axial ends of the spacer member 73.

The first external terminal 71 and the second external terminal 72 are reinforced by reinforcing plates 75. As is also shown in FIG. 12, the reinforcing plate 75 is made of, for example, stainless steel in the form of a plate. Stainless steel is a high-strength metal and has a natural potential close to that of copper. It is therefore possible to reduce galvanic corrosion at the contact portion between dissimilar metals and prevent degradation. An internally threaded portion 76 and a through hole 77 are formed in the reinforcing plate 75.

The reinforcing plates 75 that reinforce the first external terminal 71 and the second external terminal 72 are disposed so as to extend along the first external terminal 71 and the second external terminal 72. The reinforcing plate 75 for the first external terminal 71 is disposed on the surface of the first external terminal 71 that faces the second external terminal 72 (the lower surface of the first external terminal 71 in FIG. 10). The reinforcing plate 75 for the second external terminal is disposed on the surface of the second external terminal 72 that faces the first external terminal 71 (the upper surface of the second external terminal 72 in FIG. 10).

Part of each reinforcing plate 75 is sandwiched between the primary-side unit coil 11 and the insulating sheet 33. The proximal ends of the reinforcing plates 75 are inserted in the insulating sheets 33 such that the distal ends of the reinforcing plates 75 do not protrude beyond the distal ends of the first external terminal 71 and the second external terminal 72. Each reinforcing plate 75 is preferably configured so that 30% or more of the total length of the reinforcing plate 75 is inserted in the insulating sheet 33.

The terminal hole 15a and the insertion hole 15b are formed in each of the first external terminal 71 and the second external terminal 72 as the first unit coils 111 (see also FIG. 5). A first bolt 81 is inserted through the terminal hole 15a. A second bolt 82 is inserted through the insertion hole 15b.

The reinforcing plate 75 is provided with the internally threaded portion 76 at a position corresponding to the terminal hole 15a. The internally threaded portion 76 is preferably formed using a so-called burring tap screw that forms a screw hole in a cylindrical portion formed by a burring process in which a hole is punched in the reinforcing plate 75 and a conical mold is then passed through the hole to extend the hole into a cylindrical shape while widening it. Alternatively, the internally threaded portion 76 may be integrally welded to the reinforcing portion 75. The through hole 77 for inserting the second bolt 82 therethrough is formed in the reinforcing plate 75. The reinforcing plate 75 is preferably made of a thin plate (e.g., 1.5 mm). If the reinforcing plate 75 has a large thickness, a space is created due to the thickness of the reinforcing plate 75 when the proximal end of the reinforcing plate 75 is inserted into the insulating sheet 33. The larger the thickness of the reinforcing plate 75, the larger the space becomes, and the farther the primary-side coil 10 and the secondary-side coil 20 are separated, which may relatively reduce coupling as a transformer.

It is therefore preferable to use a thin reinforcing plate 75 while ensuring that the internally threaded portion 76 has a sufficient thread length, and to integrally form the internally threaded portion 76 in the thin reinforcing plate 75 by the burring process, welding, etc.

A connection terminal of an external power supply, not shown, is connected to the first external terminal 71 by the first bolt 81. Specifically, the connection terminal of the external power supply, not shown, is sandwiched between the first bolt 81 and the first external terminal 71 by tightening the first bolt 81 through the internally threaded portion 76 of the reinforcing plate 75.

Similarly, a connection terminal of the external power source, not shown, is also connected to the second external terminal 72 by the first bolt 81. Specifically, the connection terminal of the external power supply, not shown, is sandwiched between the first bolt 81 and the first external terminal 72 by tightening the first bolt 81 through the internally threaded portion 76 of the reinforcing plate 75.

The upper end of the spacer member 73 is fixed by tightening into the screw hole 73a of the spacer member 73 the second bolt 82 inserted through the insertion hole 15b of the first external terminal 71 and the through hole 77 of the reinforcing plate 75.

The lower end of the spacer member 73 is fixed by tightening into the screw hole 73a of the spacer member 73 the second bolt 82 inserted through the insertion hole 15b of the second external terminal 72 and the through hole 77 of the reinforcing plate 75.

As described above, in the present embodiment, the first bolt 81 is used to connect the connection terminal of the external power supply, not shown, and the second bolt 82 is used to fix the spacer member 73.

Specifically, using only one bolt to connect the connection terminal of the external power supply, not shown, and to fix the spacer member 73 is disadvantageous because if the spacer member 73 becomes loose, the connection terminal of the external power supply also becomes loose, so that the operation of the welding transformer 100 may become unstable.

However, using separate bolts, namely the first and second bolts 81, 82, as in the present embodiment is advantageous because even if the second bolt 82 becomes loose, the first bolt 81 does not become loose, and therefore the operation stability of the welding transformer 100 will not be adversely affected.

Moreover, since the first bolt 81 for connecting the connection terminal of the external power supply and the second bolt 82 for fixing the spacer member 73 are located away from each other, heat generated near the connection terminal is less likely to be transmitted to the spacer member 73. The influence of the heat generation can thus be minimized.

### Effects of Embodiment

As described above, according to the welding transformer 100 of the present embodiment, the spacer member 73 is disposed between the first external terminal 71 of the first unit circuit 16 and the second external terminal 72 of the second unit circuit 17 in the primary-side coil 10. Therefore, the spacer member 73 can reduce the possibility of the first external terminal 71 and the second external terminal 72 bending toward each other. As a result, short-circuiting between the first external terminal 71 and the second external terminal 72 can be reduced.

Since the reinforcing plates 75 are placed along the first external terminal 71 and the second external terminal 72, the first external terminal 71 and the second external terminal 72 can be reinforced against bending, and the rigidity of the first external terminal 71 and the second external terminal 72 can be increased.

Since the reinforcing plates 75 are disposed on the opposing surfaces of the first external terminal 71 and the second external terminal 72, the rigidity of the first external terminal 71 and the second external terminal 72 is further increased, and workability is improved. Specifically, when assembling the welding transformer 100, the second bolts 82 are inserted from the outer surface (upper surface in FIG. 10) of the first external terminal 71 and the outer surface (lower surface in FIG. 10) of the second external terminal 72 to connect the terminals of the external power supply, not shown, and fasten the spacer member 73. At this time, the reinforcing plates 75 placed on the inner surface (lower surface in FIG. 10) of the first external terminal 71 and the inner surface (upper surface in FIG. 10) of the second external terminal 72 are individually fastened or fastened together by the second bolts 82. This improves workability.

Part of the reinforcing plate 75 is sandwiched between the primary-side unit coil 11 and the insulating sheet 33. This eliminates the need for a worker to hold the reinforcing plate 75 so that it does not fall during the assembling work of the reinforcing plate 75, and thus improves workability.

The internally threaded portion 76 is provided integrally with the reinforcing plate 75. This allows the first bolt 81 for connecting the terminal to be tightened through the female threaded portion 76 without using a nut besides the reinforcing plate 75, and thus improves workability.

The reinforcing plate 75 is fastened at two different positions by the first bolt 81 and the second bolt 82. Therefore, rotation of the reinforcing plate 75 about one bolt can be restricted by the other bolt. As a result, loosening of the bolts due to rotation of the reinforcing plate 75 can also be reduced.

### Other Embodiments

The above embodiment may be configured as follows.

The above embodiment illustrates an example in which the primary-side unit coils 11 of the primary-side coil 10 and the secondary-side unit coils 21 of the secondary-side coil 20 (see FIG. 3) are made of copper plates. However, a material other than copper may be used depending on the electrical resistance ranges allowed for the primary-side coil 10 and the secondary-side coil 20. That is, the primary-side unit coils 11 and the secondary-side unit coils 21 can be any plate-like conductors whose electrical resistances fall within their allowable ranges.

As described above, the present invention is practically advantageous in that it can reduce short-circuiting between external terminals due to bending of the external terminals. The present invention is therefore extremely useful and highly industrially applicable.

What is claimed is:

1. A welding transformer comprising a primary-side coil, the primary-side coil being a stack of a plurality of primary-side unit coils that is plate-like conductors, wherein
the primary-side coil includes a first unit circuit in which a predetermined number of the primary-side unit coils are connected in series, and a second unit circuit in which a predetermined number of the primary-side unit coils are connected in series,
the primary-side unit coil includes a body portion extending in an annular shape and an external terminal extended from the body portion, and
the external terminal includes a first external terminal provided in the first unit circuit and a second external terminal provided in the second unit circuit, the welding transformer further comprising:
an insulating spacer member disposed between the first external terminal and the second external terminal.

2. The welding transformer of claim 1, further comprising:
a reinforcing plate that extends along either or both of the first external terminal and the second external terminal.

3. The welding transformer of claim 2, wherein
the reinforcing plate is disposed on opposing surfaces of the first external terminal and the second external terminal.

4. The welding transformer of claim 3, further comprising:
an insulating sheet that covers a surface of the primary-side unit coil, wherein
part of the reinforcing plate is sandwiched between the primary-side unit coil and the insulating sheet.

5. The welding transformer of claim 3, wherein
each of the first external terminal and the second external terminal has a terminal hole through which a first bolt is inserted, and
the reinforcing plate is provided with an internally threaded portion at a position corresponding to the terminal hole, the internally threaded portion being a portion through which the first bolt is tightened.

6. The welding transformer of claim 5, wherein
the spacer member is fastened to the first external terminal and the second external terminal by a second bolt, and
the reinforcing plate has a through hole through which the second bolt is inserted.
